(19) United States
(12) Patent Application Publication
(10) Pub. No.: US 2007/0250550 A1
(43) Pub. Date: Oct. 25, 2007

(54) Systems and methods of providing versioned user information to an entity

(76) Inventor: Joern Berninger, Alsfeld (DE)

Correspondence Address: CARR & FERRELL LLP, 2200 GENG ROAD, PALO ALTO, CA, 94303, US

(21) Appl. No.: 11/788,493

(22) Filed: Apr. 20, 2007

Related U.S. Application Data
(63) Continuation-in-part of application No. PCT/EP06/70133, filed on Dec. 21, 2006.
(60) Provisional application No. 60/794,150, filed on Apr. 20, 2006.
(60) Provisional application No. 60/808,823, filed on May 26, 2006.

(51) Int. Cl. G06F 17/30

(52) U.S. Cl. 707/203

(57) ABSTRACT

Systems and methods of providing versioned user information to an entity. A media is configured to be provided by a user to an entity. Versioned user information comprising information about the user is associated with a first key, the first key at least partially based on an identity of the entity. The first key may be displayed as a sequence of characters on the media and usable by the entity to provide access to the versioned user information. The key is suitable for distribution on a business card and may be human and/or machine readable.

### CROSS-REFERENCE TO RELATED APPLICATIONS

This application is a continuation-in-part and claims the priority benefit of Patent Cooperation Treaty application number PCT/EP2006/070133 filed Dec. 21, 2006 and titled “Methods and Systems for Exchanging Contact Information,” which claims the priority benefit of U.S. Provisional patent application No. 60/794,150 filed Apr. 20, 2006 and titled “Unique TAG for Exchange of Information” and of U.S. Provisional patent application No. 60/808,823 filed May 26, 2006 and titled “Systems and Method for Managing Information Associated with a Key for Exchanging Information.” The disclosure of each of the above patent applications is hereby incorporated by reference.

### BACKGROUND

1. Field of the Invention

The present invention relates generally to information management, and more particularly to systems and methods of providing versioned user information to an entity.

2. Description of Related Art

A business card may include the following information about a user: contact details (e.g., the user's name, position, title, address, phone, fax, email address), information about the user's company affiliation (e.g., company name, group information, website, company logo), and/or additional information (e.g., Skype™ name, or a marketing tagline). An entity (e.g., an individual person, a company or organization, and/or an information system) receiving a business card may be provided this information for several reasons. For example, the user may wish to provide the entity with the user's contact information, information about the user's title or position in a company (if applicable), and/or additional information such as a marketing tagline.

When a user moves between physical locations, receives a new phone number or new email address, changes their position within a company or organization, or makes other changes, the user's information may change. Disadvantageously, these changes may necessitate the need to update the user's information and the user's business card may need to be reprinted. A user may, for a time, make manual corrections on the business card to update phone numbers, for example, but eventually a new version of the business card is needed. Thus, in practical use, the user may have to reprint their business cards frequently so that the information stays current. An additional disadvantage of a business card is that there is no commonly accepted way to indicate the version of a business card. The entity receiving the card has no way of knowing if the information on the business card is out of date.

Furthermore, when a user provides a business card to an entity, the user gives up control over his information, which may allow other entities to gain access to that information. Personal information, and especially contact information, can be captured easily and potentially exposed to a global community. Once exposed, the user's information is beyond the user's control. Thus, a still further disadvantage of a business card is the inability to monitor and trace the disclosure of the user's information.

Yet another disadvantage of the conventional ways of providing user information to an entity is the fact that business cards, for example, are not easily configured for one-time use or for special events. A business card does not allow a user an opportunity to identify contacts established at an event (where the business card may have been provided to an entity), because the business card's use may not be easily traced to the event. This may be particularly true when a user may have widely distributed his business card before and/or after the one-time use or special event.

Therefore, there is a need for a business card that provides updated contact information about a user and does not have to be frequently re-printed, that allows the user to monitor and trace the disclosure of the user's information, and that can be configured for one-time use or for special events.

### SUMMARY

The present invention includes systems and methods to provide versioned user information to an entity. A media is configured to be provided by a user to an entity. Versioned user information comprising information about the user is associated with a first key, the first key at least partially based on an identity of the entity. The first key may be configured as a sequence of characters that are displayed on the media. The first key is usable by the entity to provide access to the versioned user information.

A second key may be associated with the versioned user information, the second key partially based on the identity of the entity. The second key is machine readable and is usable by the entity to provide access to the versioned user information.

The first key may be a first encrypted key that is further partially based on applying at least a first hash function to the versioned user information, and the first hash function may be a first cryptographic hash function. The second key may be a second encrypted key that is further partially based on applying at least a second hash function to the versioned user information, and the second hash function may be a second cryptographic hash function.

In one embodiment of the presently disclosed invention, a computer readable storage medium has embodied thereon a program. The program is executable by a processor for performing a method comprising receiving versioned user information from a user. The method may include receiving versioned user information from a user, associating the versioned user information with a version identifier, generating a key associated with the versioned user information and the version identifier and an entity, encrypting the key to produce an encrypted key, providing the encrypted key to the user, receiving the encrypted key from the entity, checking a validity of the encrypted key, determining the key based on the encrypted key, determining the versioned user information associated with the key, updating an access database based on the encrypted key, and providing the versioned user information to the entity.

### BRIEF DESCRIPTION OF THE DRAWINGS

FIG. 1 illustrates a business card including first key and a second key in an exemplary embodiment.

FIG. 2 is a flow chart illustrating methods of providing versioned user information to an entity in an exemplary embodiment.

FIG. 3 is a block diagram illustrating modules of a computer program for key management in an exemplary embodiment.

FIG. 4 is a flow chart illustrating methods of user identification in an exemplary embodiment.

FIG. 5 is a flow chart illustrating methods of a contact profile management in an exemplary embodiment.

FIG. 6 is a flow chart illustrating methods of key generation in an exemplary embodiment.

FIG. 7 is a flow chart illustrating methods of key information requests and methods for providing the contact profile to the entity in an exemplary embodiment.

### DETAILED DESCRIPTION

The embodiments discussed herein are illustrative examples of the present invention. As these embodiments are disclosed and described with reference to the figures, various modifications or adaptations of the systems, methods and/or the computer program disclosed herein may become apparent to those skilled in the art. All such modifications, adaptations, and/or variations that rely upon the teachings disclosed herein, and through which these teachings have advanced the art, are considered to be within the scope of the present invention. Hence, these descriptions and drawings should not be considered in a limiting sense. It is understood that the present invention is in no way limited to only the embodiments disclosed herein.

The present invention includes systems and methods to provide versioned user information to an entity. Versioned user information may be any information associated with a user at a particular date and/or time, such as the user's current home residence contact information, the user's current employer and contact information, and so on. An entity may be an individual person, a group of persons, a company or organization, and/or an information system. Embodiments of the present invention allow for versioning the user's information, selectively preserving the anonymity of the user's information, and associating the versioned user information with one or more keys. The versioned user information may be disclosed only to entities which have access to the one or more of the keys.

The user may generate keys based on the identities of specific entities. By providing specific keys to particular entities, the user may control, on a case-to-case basis, which entities have access to certain contact profiles. A contact profile may include a user's information that has been versioned and limited to a user-selected set of information. Furthermore, a key may be associated with a contact profile that may be provided in a language specific to a particular entity. Thus, whereas the key may be language independent (e.g., a numerical or alphanumeric sequence, a barcode, etc.) the versioned user information and contact profile may be provided to an entity in a specific language. In one example, a German user may enter versioned user information in the German language and generate a key for a Chinese entity. Using the key, the Chinese entity may then be provided with the contact profile in the Chinese language. A user may have several keys, so that the different keys may be provided to different entities.

Using keys associated with versioned user information provides for the separation of the versioned user information from the key, the facile entry of a key into a database to access the contact profile, and/or the use of both human and machine reading (machine and/or digital recognition) processes to read the key. Rather than relying on a process of providing contact information directly to an entity, the key enables the user to easily provide only a key to an entity.

The process of providing information to an entity may be facilitated because the user's key(s) can be displayed (e.g., printed) on a media, such as a business card, and/or coupled to a media. In some embodiments, the key may be encrypted using a hash function, which may be based on a cryptographic hash function. A key that is thus encrypted may not allow other users or entities to guess the versioned user information associated with the key.

A user may have a plurality of keys, each associated with different contact profiles. As described herein, each of the different contact profiles may contain versioned user information in different languages. Moreover, a user may have a plurality of categories of keys, each associated with selected parts of one or multiple contact profiles. A user may request a report describing the entity and the time of access when the user's key was used to provide a contact profile to an entity. New keys may be generated that are associated with new, updated user information. For example, a new key may be generated when an updated new contact profile is created by the user.

A user may generate a key, and an entity may access a user's contact profile, by entering the key into a database and retrieving the contact profile. Such a database may be provided using a computer system comprising a server, a network, and the database, with mechanisms for user-login, user-identification, contact profile-identification, key recognition, key generation, key encryption, and key management. Furthermore, such a computer system may comprise sub-processes for entering data, administering data, user contact profiles, and versioned user information, converting versioned user information and contact profiles between languages, retiring or deactivating users, and for generating reports.

By using a plurality of keys, each associated with different contact profiles, a user may create media and keys configured for special events (e.g., a trade show, a marketing campaign, etc.). A user may configure a business card or a marketing brochure, for example, with a key associated with versioned user information specific to the special event. In combination with the computer system described herein, the entity may download the versioned user information associated with the key, and the user can track and monitor the usage of the key. Thus, the user may track key use resulting from the special event. Furthermore, a user may provide versioned user information at a first use of the key by the entity, and different versioned user information at a later use of the key.

A business card provider therefore has the need to increase traceability of his personal information, which can be implemented by configuring a media with the herein described system.

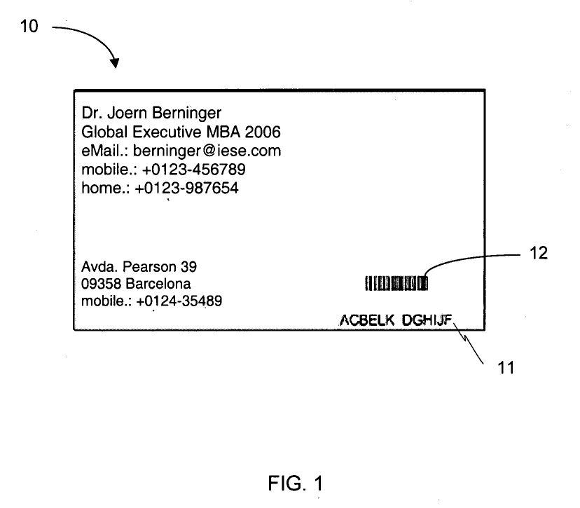

FIG. 1 illustrates a business card including first key and a second key in an exemplary embodiment. Business card 10 comprises a business card including first key 11 and second key 12. First key 11, in FIG. 1, is configured as a sequence of characters that are displayed on the business card. First key 11 may be machine readable. Second key 12, in FIG. 1, is shown as a bar code that may be machine readable and is coupled and/or displayed on the business card. Although FIG. 1 depicts second key 12 as a bar code, in various embodiments second key 12 may be generated by a radio frequency identification (RFID) device (not shown) coupled to business card 10. Alternatively, any other media configured to provide identification information may be substituted in place of Business card 10. Other media may include including an electronic message (such an email message), a virtual card (vCard), an identification badge and so on.

First key 11 may be encrypted by applying at least a hash function to versioned user information. Furthermore, the hash function used to encrypt the versioned user information may be based on a cryptographic hash function. Second key 12 may also be encrypted by applying at least a hash function to the versioned user information, and this hash function, too, may be based on a cryptographic hash function.

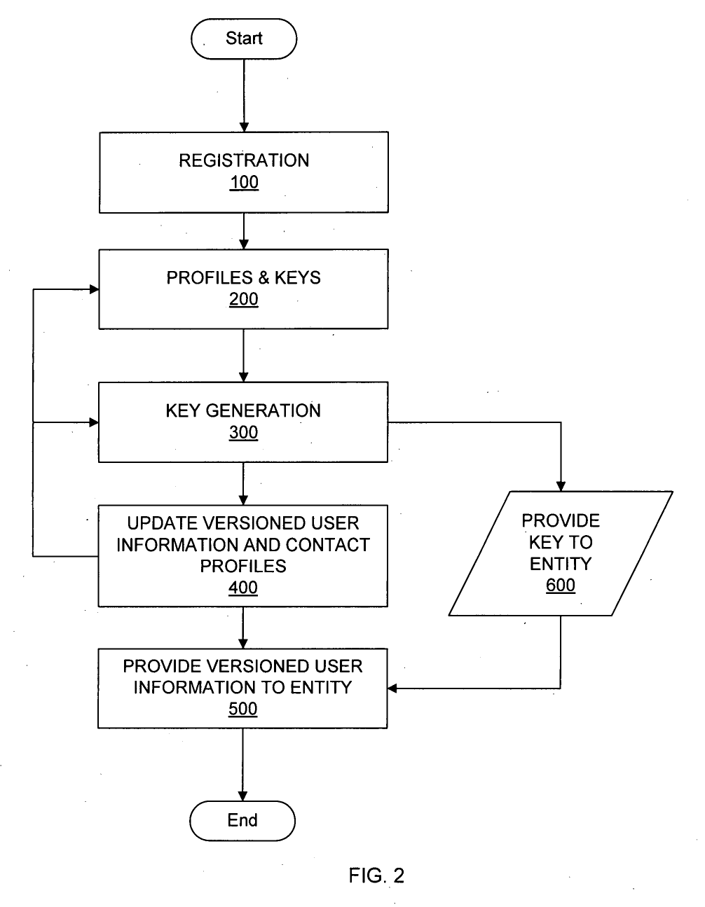

FIG. 2 is a flow chart illustrating methods of providing versioned user information to an entity in an exemplary embodiment. In step 100, a user registers their versioned user information with the computer system (not shown) described herein. A user will typically receive credentials, such as a user-ID and password, in return.

At step 200, the user enters and stores their versioned user information into the database and creates contact profiles for specific entities. For example, a user may enter a full set of their user information, and identify one contact profile for friends, another contact profile for family members, and a third contact profile for co-workers. The computer system may associate the versioned user information with a version identifier.

At step 300, a first key and optionally a second key are generated and may be encrypted, as described herein with reference to FIG. 1. Depending on the number of different entities to which the user desires to provide keys, the user may request one or more keys, which may be provided to the user by the computer system at step 300.

At step 600, the user may provide one or more keys to an entity. In various embodiments, the user may display the one or more keys on a business card, such as described with reference to FIG. 1, and then provide the business card to the entity. In various embodiments, the entity may be an information system, for example a personal information manager, or a messaging and collaboration client such as Microsoft Outlook® and/or a customer relationship management (CRM) system.

At step 500, the computer system may receive an encrypted key from an entity and provide versioned user information (e.g., a contact profile) to the entity. The computer system may process the encrypted key by checking the validity of the encrypted key, determining the key based on the encrypted key, determining the versioned user information associated with the encrypted key, and optionally updating and tracking the encrypted key using an access database.

At step 400, the user may update their versioned user information, change their contact profiles, and generate new keys. Changing certain parts of a contact profile may lead to a new version of the original contact profile. This process may require that a new key is generated to uniquely identify this contact profile. Thus, the profile updating process triggers Step 300 and a new key may be generated. However, multiple keys may be associated with the same contact profile.

A category may be associated with each key. This may facilitate allowing for changes in subsets of data and for displaying different parts of a contact profile in different ways. A category (e.g., a category identifier or category-ID) describes a set of data which may be displayed from a selected contact profile. Furthermore, a category-ID may be associated with parts of several contact profiles.

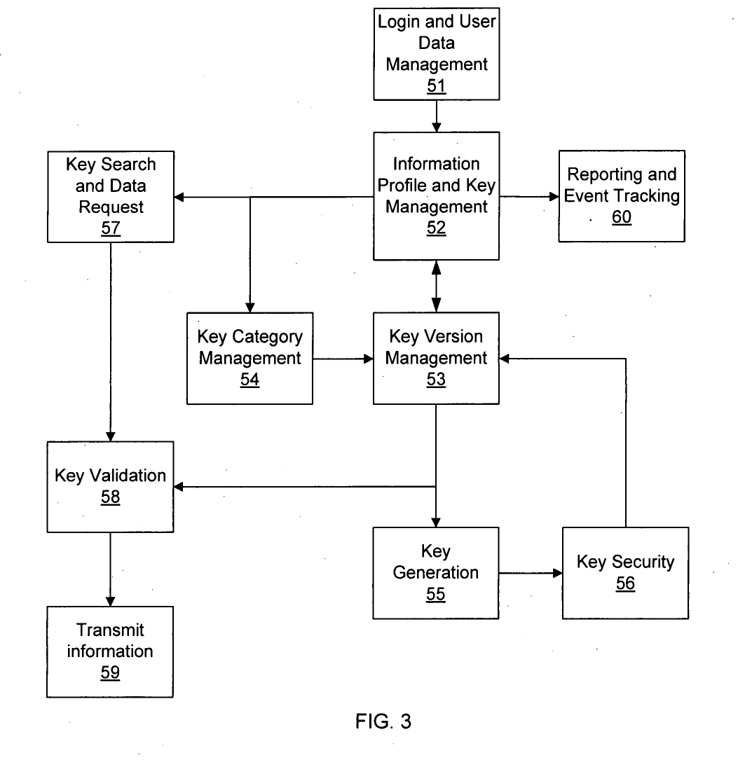

FIG. 3 is a block diagram illustrating modules of a computer program for key management in an exemplary embodiment.

A module (or application), as referenced in the present invention, may generally be understood as a collection of routines that perform various system-level functions and may be dynamically loaded and unloaded by hardware and device drivers as required. The modular software components described herein may also be incorporated as part of a larger software platform or integrated as part of an application specific component.

The modules of the computer program may be executed by a processor (not shown) included in the computer system described herein. The computer program may comprise modules, illustrated in FIG. 3, that may be configured to execute the following functions: Login and User Data Management 51, Information Profile and Key Management 52, Key Version Management 53, Key Category Management 54, Key Generation 55, Key Security 56, Key Search and Data Request 57, Key Validation 58, Transmit (Retrieve and Download) Information 59, and Reporting and Event Tacking 60. The functions of the modules described with reference to FIG. 3 may be implemented using the methods described with reference to FIGS. 2 and 4-7.

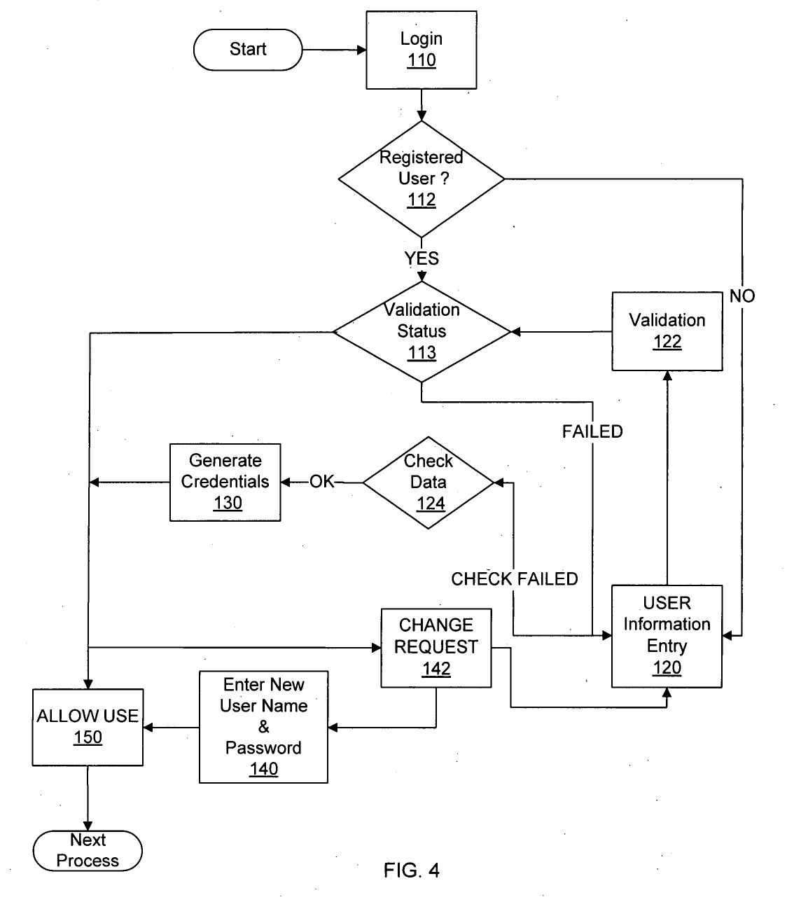

FIG. 4 is a flow chart illustrating methods of user identification in an exemplary embodiment. The computer program may be executed to perform the method steps using a processor (not shown) included in the computer system described herein. At step 110, the user logs in. A user login comprises the entry of a user identification (user-ID) and password. Alternatively, the user login may comprise the entry of a user name and user-name-password or a valid key and a key-password. New users of the system (unregistered users) do not have a username or password and are transferred directly to step 120.

In step 112, the user information is checked for registration status. The credentials (e.g., user-ID and password) are checked against the information stored in a database. If the credentials were provided correctly, the user proceeds to step 113. Otherwise, if the user has provided invalid or failed credentials, the user may be requested to re-enter the user's credentials. This procedure may also include a counter function, which prevents the user from logging-in after a certain number of failed attempts. If the user is a registered user, the user is allowed to use the computer system at step 150. A previously unregistered user (e.g., a new user) is required to enter user information at step 120.

At step 120, the new member registration process may take place on an individual user basis or in a batch mode. In a batch mode, an organization comprising a plurality of users may register all of their individual users in one or multiple batches. After successful data entry, the data may be validated at step 122.

In step 122, the user information may be validated manually or automatically. For example, the user information may be validated by comparing the data provided with other datasets such as phone books, etc. If a validation check gives a failed validation status, then the user may be requested to update the user's data entered at step 120, or eventually the user will be excluded from using the computer system.

At step 124, user information may be checked to fulfill minimal criteria. Criteria for this check may include the availability and correctness of name and email addresses as well as the correctness and format of the data provided.

At step 130, a new user with a positive basic data check at step 124 may be provided with credentials. The credentials may comprise a user ID and password ID. New users may receive a provisional user ID, which may allow new users to use the computer system for a limited amount of time, for a limited number of accesses, or with limited functionality.

At step 150, users who have passed the login, check and validation steps 110, 112 and 113, and new users who passed step 130 are now allowed to use the computer system.

At step 142, a user of the system may also initiate a change request to change credentials or user information at step 140. A change request may also comprise a user requesting the update or change of the user's versioned user information at step 120, where a user may enter, edit, and/or updates the user's information.

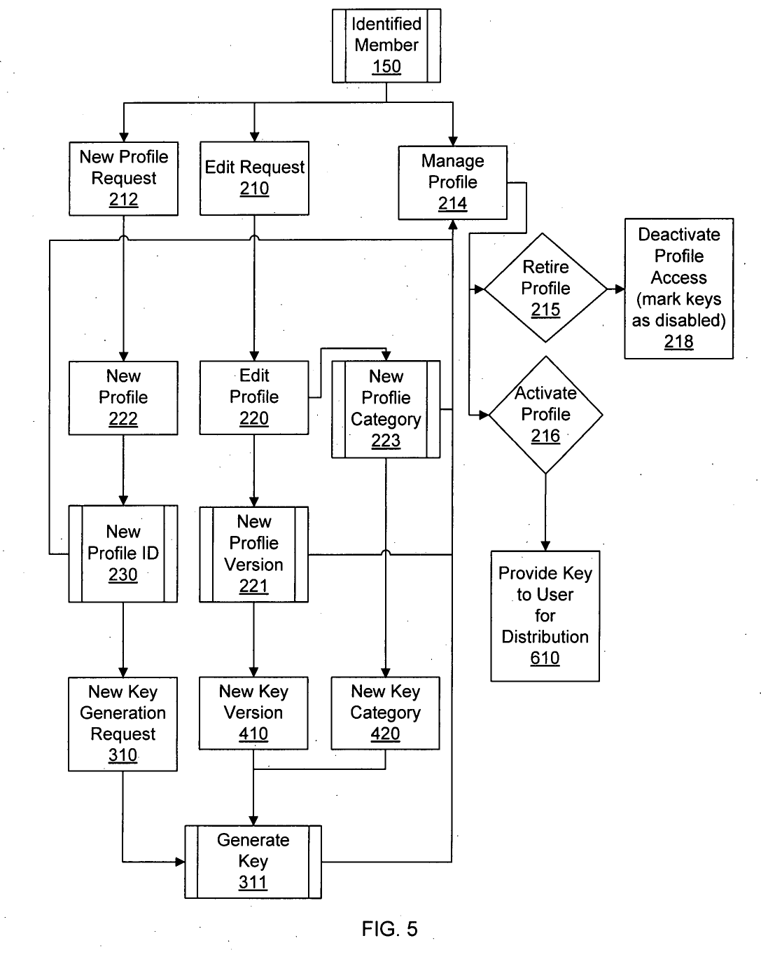

FIG. 5 is a flow chart illustrating methods of a contact profile management in an exemplary embodiment. A computer program may be executed to perform these steps using a processor (not shown) included in the computer system described herein. Updates and changes to a user's contact profile associated with a key may trigger the computer program to automatically generate a new version identifier associated with the versioned user information. A user and an entity may search for the more recent and/or most current contact profile using the keys described herein.

Once a registered user is identified at identified member step 150, the user may perform an edit request step 210, or generate a new profile at new profile request step 212. The user may alternatively use the manage profile step 214 of the program to activate profile step 216, or retire profile step 215 and deactivate profile step 218. A user may manage their profile data coming directly from the identified member step 150, one of the profile generation (or similar function) steps 212, 222, 230, 310 and 311, or the edit request (or similar function) steps 210, 220, 221, 410 and 311. A user may interrupt and save their work and come to the manage profile step 214 by leaving the steps 221, 223 or 230.

In the case of a request for generation of a new contact profile, a user may select new profile request step 212, which then leads the user to the new profile generation menu 222, where the users may input, upload edit and change their contact profile. The generation of a contact profile may be done manually or automatically using a software client or a batch uploading tool. Once the user is finished with the contact profile, or the data is received and the process is concluded, a new profile ID is generated at step 230, and new key generation request step 310 may be performed. The request to generate a new key triggers generate key step 311.

At edit request step 210, the user can update or edit the information at edit profile step 220, or create a new profile category step 223 of an existing contact profile. Following edit profile step 220, a new contact profile may be generated at new profile version step 221, which may be followed by new key version step 410. The new category profile step 223 may lead to new key category step 420 and to generate key step 311.

A user may return to the management profile process where the users can either decide to leave the profile and key management processes, or perform further administrative tasks at manage profile step 214. A user or administrator of the computer system may decide retire a single profile or multiple profiles at retire profile step 215 followed by the decision to mark the associated keys as disabled at step 218. An administrator of the computer system may also be able to deactivate the access to these keys completely and remove profiles and keys.

With the activation of the profile and key, a user receives the key for distribution at step 610. The key may not be provided or visible to the user, before the user activates the profile and key. This insures that the user makes a conscious decision on the distribution of the key and the quality of the user's versioned user information.

The steps illustrated in FIG. 5 may comprise the functions described in additional detail, below:

Step 150—A user is identified and allowed to use the computer system.

Step 212—A member may request the generation of a new profile. A new profile context menu will be opened or the user may perform this step automatically or use a software client to perform this step.

Step 222—The user inputs data into the user's contact profile. This step may be also performed by the computer system administrator. The input of information may be performed manually, or in batch mode for multiple users, by an administrator of the computer system or automatically for an individual user.

Step 230—New profile ID step 230 follows step 222, and a new profile is generated which results in the generation of a new profile ID associated with the contact profile.

Step 310—A new key generation request may be generated at new key generation request step 310.

Step 311—A new key is generated. A key may have a version and a category associated with the key.

Step 210—A profile edit request is based on updating a single contact profile or multiple contact profiles. Step 210 may be manually performed or automated. A user may select to update and generate a new category of a profile, by duplicating or selecting parts of the profile which leads to step 223, or to update and change an existing profile which leads to step 221.

Step 223—The user may select to duplicate all or only parts of the versioned user information in order to create a new category of a profile. A new category can be created by either duplication of a profile and changing and editing the information and/or by selecting a subset of data of an existing profile.

Step 420—After successful completion of the category generation process, a new category-ID is generated followed by the generation of a new key at step 311.

Step 214—The profile management allows the user to manage the user's contact profile.

Step 215—The deactivation or retirement of a profile may leave a copy of the profile in the database. By retiring the profile a user can allow other users or entities to search for the keys associated with the contact profile, but the contact profile may be displayed as out of date, or the contact profile may not display versioned user information.

Step 218—Following the deactivation of a contact profile, the keys associated with the contact profile may be marked as disabled. An administrator of the computer system may decide to remove the keys and make the keys inaccessible to entities.

Step 216—A user may manage multiple contact profiles, but must activate a contact profile to enable other users to find and retrieve the information in the contact profile using an associated key.

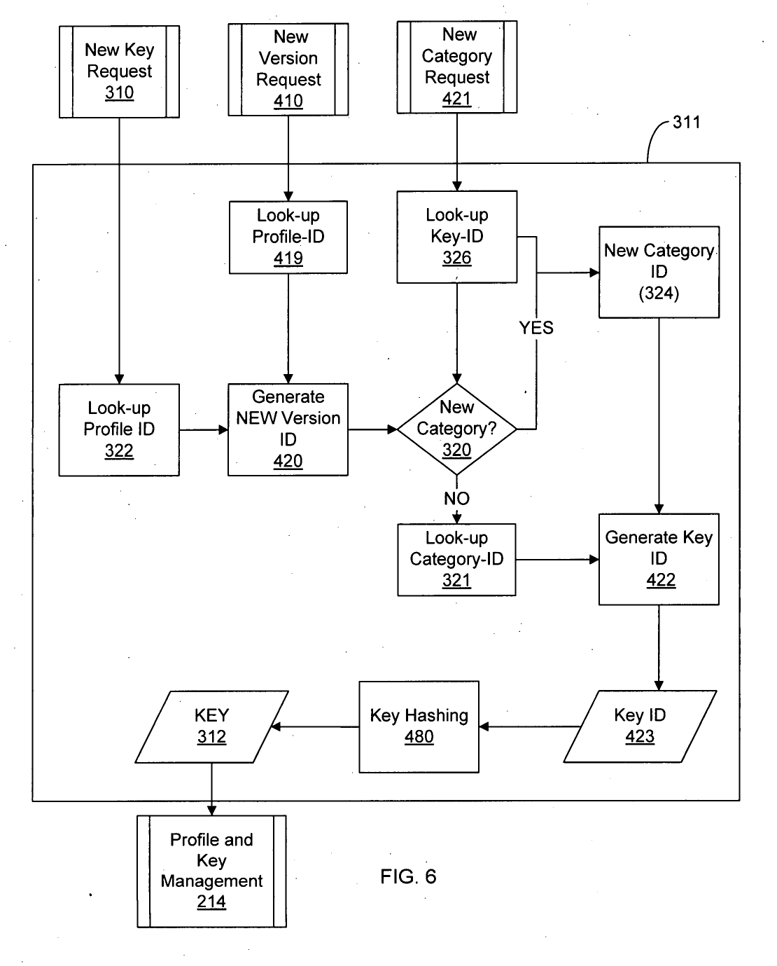

FIG. 6 is a flow chart illustrating methods of key generation in an exemplary embodiment. A new key is generated with the request for a new key, the request for a new version of a key, or with the request for a new key category. The key generation process may lead to an intermediary key ID, which then is transformed into a key available for distribution. The key ID may comprise the profile-ID, version-ID and category-ID, and may also be generated independent of all three possible identifiers.

The requests for the generation of a new key derive from a new key generation request step 310, a request for a new key version step 410 or new category request step 421. In order to identify a specific information profile, version and category, a new key is generated by any of these requests.

In the case of generating a new key for a new contact profile, the generation of new keys comprises one or more of the following steps: New key generation request step 310, Look-up profile-ID step-322 (which may be similar and/or equivalent to step 419), Generation of a new version-ID step 420, and check new category step 320 and new category-ID step 324. The computer system may use a combination to these IDs to generate a unique key ID at step 423 or generate a key ID which is independent of the previous IDs. The key ID is then is hashed in key hashing step 480 for encryption and security, producing the encrypted key at step 312. Hashing the key may be performed using a cryptographic hash function.

A new key version step 410 leads to the lookup of the associated profile ID step 419, which is then followed by the generation of a new version-ID step 420, followed by the check for an existing category ID at step 320. If a category is available and the user leaves the category unchanged, then the category ID lookup is performed at step 321 and generate key ID step 422 is followed by Key ID step 423. A new category request step 421 results in the lookup of the existing key ID number at step 326, followed by step 320 for a new category request, or alternatively leads to the generation of a new category ID at step 324, followed by generate key ID step 422 and Key ID step 423.

The key ID may comprise internal information, such as users IDs, profile IDs version and category information. In order to secure the key ID, a key hashing step 480 of the key ID step 423 may be used to generate the encrypted key at step 312.

A new key generation request step 310 is executed with the computer system and starts the look-up profile ID step 322 of generate key step 311. Look-up profile-ID step 322 provides the information on the contact profile ID to enable identification of a specific contact profile.

A new key version step 410 is executed with the computer system and starts the look-up profile ID step 419 of generate key step 311. The generation of a new version does not require generating a new profile ID. The profile ID is looked-up at step 419 and provided to the system. The next step leads to the generation of a new version ID. A new version ID is generated at step 420. If an existing version ID is available then the new version may be generated by an incremental increase in the version identification number.

A new category request step 421 is executed using the computer system and starts the look-up key ID step 326. Step 326 looks-up the key ID, which combines or identifies the profile ID and version ID of a specific contact profile. The process then lead to the generation of a new category ID at step 324, or via step 321.

At step 320, a new category may be combined with a request for new version of a key. If a new category is requested, then step 324 follows, if not then step 321 follows. At step 321, a category update is not required in the key generation process, and look-up of the existing category ID may be performed.

At step 422, a key ID is generated by combination of the IDs or by linking the previous IDs to a unique new key ID. A key ID is generated at step 423 as a result of step 422. For security reasons, a key hashing step 480 of the key ID may be performed. The hashing may be performed using a cryptographic hash function. An encrypted key is generated at step 312 as a result of step 480.

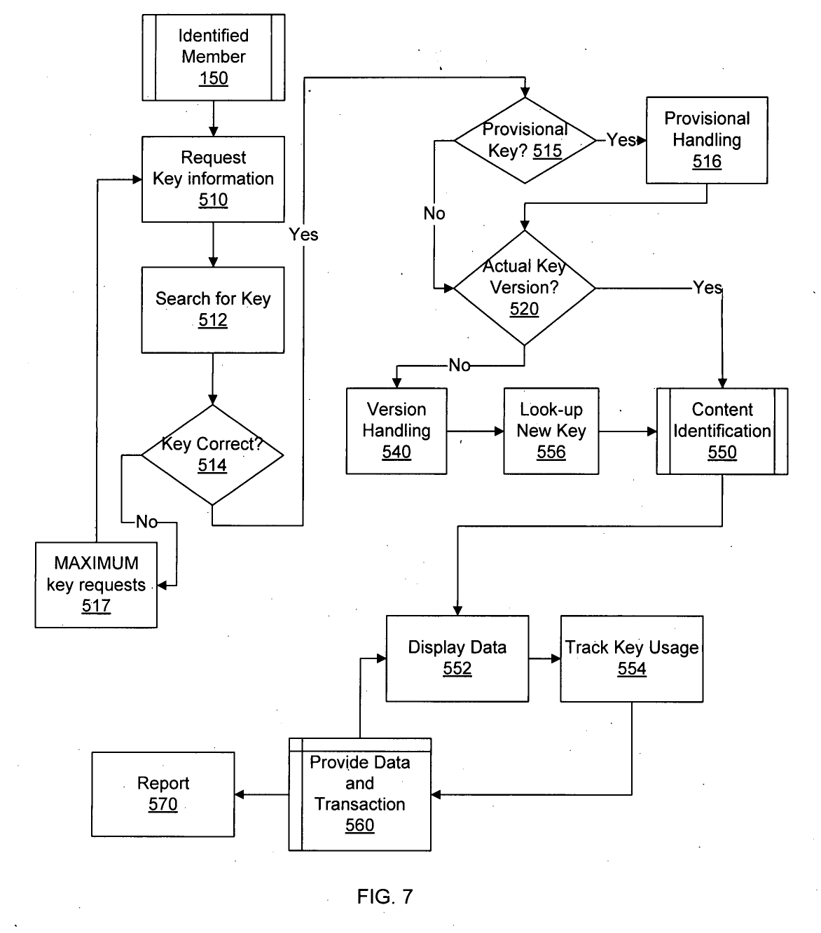

FIG. 7 is a flowchart illustrating methods of key information requests and methods for providing the contact profile to the entity in an exemplary embodiment. A user may login with their username or user-ID, or key and password (referred to as “credentials” for the combination of User-name and password, or user-ID and password, or key and password). Each user may have a user-ID. Non-registered users (also known as non-members) may be requested to enter their personal information and receive a provisional user-ID generated by the computer system. Users and non-members may use a website or software client application to enter their contact profiles over a network into the computer system.

Users may generate and edit multiple contact information profiles. With the generation of a contact profile, a key is generated within the system. Users will be provided with the key by activating the profile. Users may be provided with a different, unique key for each contact profile and may distribute the key(s) to entities and other users to grant these entities and other users' access to the user's contact profiles. Users may print their key(s) on documents as well as using their key(s) as a signature in emails and in electronic communications.

Users and entities may access the contact profile associated with a key using a web-site or client application to enter the key of a member and to access the contact profile associated with the key. Users may use a client application, internet browser, or mobile phone for the purpose of reviewing the contact profile and/or for downloading it to a local client or data device. Data devices include, but are not limited to, computers, mobile phones, smart-phones, and personal digital assistants (PDAs).

The computer system may compare a key of a user with other keys stored by the user. If a more current version of the key is available, then the user or the entity may be notified and may download the current versioned user information over a network. A report may be generated for the user providing the user an overview of the identity of other users and entities who requested access to the user's versioned user information.

A user or an entity (also known as an identified member) may request a contact profile using single key or multiple keys at step 510. The request triggers the search for a key step 512 in the computer system. The search will bring up two possible results which are processed at step 514. If the key is found, then the computer system returns the result and proceeds to provisional key step 515. In case that the key was not found, step 517 is triggered, and the identified member may be allowed to reenter the key at step 510, up to a maximum number of false, non-existing key entries.

If the identified member enters the key correctly, then it will be checked at provisional key step 515. If the key is a provisional key, then provisional handling step 516 is triggered. Step 516 may include various options such as limiting the number of key requests and sending warnings or notifications to the user that a specified number of key requests have been exceeded.

At step 520 the key is checked to determine if it is associated with current versioned user information (also know as checking the actuality of the key). Particularly when a key has been provided to an entity on a printed media, it may be out of date, and a new key version may be available and key version handling step 540 is performed. The new version, which means a new key, is looked-up at step 556 and then the versioned user information with the new key version is looked-up at step 550. Both the new key and the contact profile with the new key may be displayed or provided to the user or an entity at step 552. The versioning of the key as described herein makes it easy for users to regularly generate a new contact profile and a new key.

The use of a key and the version of the requested key are tracked at step 554. The user (and/or a service operating the computer system and providing the systems and methods of providing versioned user information to an entity) may request a report at step 570.

In various embodiments, the steps illustrated in FIG. 7 may comprise the functions described in additional detail, below:

Step 150—A user or entity (an identified member) may look-up a contact profile the using a key.

Step 510—The user enters the key or multiple keys into a search form using, for example, a client software application.

Step 512—The key search is performed by the computer system and returns a match with a key, or an invalid key or key not found message.

Step 514—If the key is invalid or can not be found, a maximum false attempts process is triggered at step 517. If the key search provides a match, step 515 follows.

Step 517—An identified member is allowed a maximum number of false key searches per session or a maximum in total. When this maximum is exceeded, the user may be excluded from using the computer system.

Step 515—If the key is a provisional key, then the provisional key step 515 is triggered. The provisional key handling may monitor how often a provisional key has been used, and allows implementing routines such as a maximum number of provisional key requests combined with a message or notification to the user that a key request usage limit has been exceeded.

Step 520—The requested key may be out of date. If a current key is available, then the version handling step 540 is activated; otherwise step 550 is initiated.

Step 540—The version handling manages the process for looking up multiple versions of keys. If an out of date key is requested, multiple (newer) versions of the key may be available. The version handling process may select the most current version of a key for further lookup operations.

Step 556—The current key is accessed and used to look up the associated contact profile at step 550.

Step 550—The current key is used to access the associated contact profile.

Step 552—The current key and the associated contact profile are displayed. The user may download the contact profile to the user's local personal computer (PC), request an email containing the contact profile, or use a client program for synchronization with a personal information manager.

Step 554—Key usage may be tracked at step 554.

Step 560—The key usage (e.g., transaction requests) and contact profile may be provided to the user and/or entity.

Step 570—The user may request a report of key transaction requests for the user's key.

What is claimed is:

1. A system for providing versioned user information, the system comprising:
a media configured to be provided by a user to an entity;
versioned user information comprising information about the user; and
a first key associated with the versioned user information, the first key partially based on an identity of the entity and displayed as a sequence of characters on the media, the first key usable by the entity to provide access to the versioned user information.

2. The system of claim 1 further comprising:
a second key associated with the versioned user information, the second key at partially based on the identity of the entity, wherein the second key is machine readable and usable by the entity to provide access to the versioned user information.

3. The system of claim 1, wherein the first key is a first encrypted key that is further partially based on applying at least a first hash function to the versioned user information.

4. The system of claim 3, wherein the first hash function is a first cryptographic hash function.

5. The system of claim 1, wherein the second key is a second encrypted key that is further partially based on applying at least a second hash function to the versioned user information.

6. The system of claim 5, wherein the second hash function is a second cryptographic hash function.

7. The system of claim 2, wherein the second key is a barcode.

8. The system of claim 2, wherein the second key is configured for use with a radio frequency identification device.

9. The system of claim 1, wherein the media is a business card.

10. A method of providing versioned user information, the method comprising:
receiving the versioned user information from a user;
associating the versioned user information with a version identifier;
generating a key, the key associated with the versioned user information, the version identifier, and an entity;
encrypting the key to produce an encrypted key; and
providing the encrypted key to the user, the encrypted key configured for distribution to the entity.

11. The method of claim 10 further comprising:
receiving the encrypted key from the entity;
checking a validity of the encrypted key;
determining the key based on the encrypted key;
determining the versioned user information associated with the key, the versioned user information configured to be provided to the entity; and
updating an access database based on the encrypted key.

12. The method of claim 11 further comprising providing the versioned user information to the entity.

13. The method of claim 11 further comprising providing an identification of the entity to the user.

14. The method of claim 11 further comprising tracking use of the encrypted key.

15. A computer readable storage medium having embodied thereon a program, the program being executable by a processor to perform a method of providing versioned user information, the method comprising:
receiving versioned user information from a user;
associating the versioned user information with a version identifier;
generating a key, the key associated with the versioned user information, the version identifier, and an entity;
encrypting the key to produce an encrypted key;
providing the encrypted key to the user, the encrypted key configured for distribution to the entity;
receiving the encrypted key from the entity;
checking a validity of the encrypted key;
determining the key based on the encrypted key;
determining the versioned user information associated with the key;
updating an access database based on the encrypted key; and
providing the versioned user information to the entity.

16. A method of providing user contact information to an entity, the method comprising:
receiving a key from the entity;
verifying a validity of the key;
searching the database for the user contact information associated with the key;
selecting user contact information based on a category of the key; and
providing the selected user contact information to the entity, wherein the user contact information is associated with the key.

17. The method of claim 16 further comprising:
tracking use of the key by the entity; and
reporting use of the key by the entity to a user associated with the selected user contact information.

18. The method of claim 16 further comprising generating the key based on a hash function.

19. The method of claim 16 further comprising printing the key on a business card.

20. The method of claim 16 further comprising configuring the key for use with a radio frequency identification device.
